(19) United States
(12) Patent Application Publication
(10) Pub. No.: US 2025/0094594 A1
(43) Pub. Date: Mar. 20, 2025

(54) APPARATUS, METHOD AND NON-TRANSITORY MACHINE-READABLE STORAGE MEDIUM

(71) Applicants: Ned M. SMITH, Beaverton, OR (US); Vincent R. SCARLATA, Beaverton, OR (US); James BEANEY, JR., Raleigh, NC (US)

(72) Inventors: Ned M. SMITH, Beaverton, OR (US); Vincent R. SCARLATA, Beaverton, OR (US); James BEANEY, JR., Raleigh, NC (US)

(21) Appl. No.: 18/896,623

(22) Filed: Sep. 25, 2024

Related U.S. Application Data
(60) Provisional application No. 63/648,714, filed on May 17, 2024.

(51) Int. Cl. G06F 21/57; G06F 8/65

(52) U.S. Cl. CPC G06F 21/57; G06F 8/65

(57) ABSTRACT

It is provided an apparatus comprising interface circuitry, machine-readable instructions, and processing circuitry to execute the machine-readable instructions. The machine-readable instructions include instructions to obtain a request for a seamless update of at least a part of a confidential computing environment, while the confidential computing environment is handling a workload. The machine-readable instructions further include instructions to generate first attestation evidence for verifying the integrity of the confidential computing environment before updating the confidential computing environment. The machine-readable instructions further include instructions to generate second attestation evidence for verifying the integrity of the confidential computing environment after updating the confidential computing environment.

### BACKGROUND

In the field of confidential computing environments (CCEs), sensitive workloads are executed within isolated, secure environments to protect against unauthorized access and tampering. As software and security requirements evolve, updates to both the CCE and the workloads may need to be applied regularly. However, these updates can introduce new vulnerabilities or disrupt the continuity of the workload's execution, potentially compromising the system's overall trustworthiness. For example, an update might modify the workload's execution state or affect the integrity of the secure environment, leading to possible security breaches or operational inconsistencies. Therefore, there may be a desire for improved techniques to verify the integrity of a workload throughout its lifecycle.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus;

FIG. 2 illustrates a flowchart of an example of a method 200;

FIG. 3 illustrates a flow chart of a seamless update applied to a workload in a CCE with a collection of historical attestation evidence collection;

FIG. 4 illustrates a CCE runtime measurement of a swapped out workload; and

FIG. 5 illustrates an attestation evidence collection architecture.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

Confidential computing environments (such as TEEs such as Intel® TDX or SGX) may require updating while a workload executes in the CCE without forcing the workload to terminate or be live migrated. The CCE attestation evidence that existed prior to update may be preserved and a post-update attestation records the new state of the CEE. A seamless update collects a snapshot the workload before and a snapshot the workload after the update and/or the CEE using attestation. An attestation evidence structure may be used to record a collection of historical evidence (for example all previous environments in which the workload existed). After the seamless update, the updated CCE may be attested so that a recent snapshot of evidence is added to the collection. The proposed technique may use confidential computing technology to integrity protect attestation evidence collection histories. An attestation evidence collection history may be generated for each layer sub-environment upon which a CCE for (example a trusted domain (TD) environment) depends for trustworthy computing.

The seamless update of a CCE workload may be applied to the workload runtime image. Unlike a boot time image, where the executed image is temporary, a runtime image may remain runnable even if the image is paged out. CCE attestation procedure may collect measurements of the in-memory representation of the image (or at least a memory swizzled representation) that may be used to generate reference measurements that compare with attestation evidence. A local or remote attestation verifier (e.g., Amber/embedded Amber) may comprehend the semantics of an attestation evidence collection history and verify it as part of a traditional (non-historical) verification request. The proposed technique may collect CCE measurements, both before and after the CCE and/or workload image may be updated and may further maintain an attestation evidence collection history of attestation evidence collected during the CCE workload lifetime. This historical attestation evidence creates a long-term picture of the workload's trust properties as it evolves and/or responds to security events that result in workload image updates. This attestation evidence history may be maintained in an industry standard format to better enable interoperability among a community of attestation verifiers. Nevertheless, the standard format may be extended by a vendor to account for vendor-specific properties and capabilities. The historical attestation evidence may be digitally signed for authentication and integrity. The attestation history may be stored on a local server, cloud service (such as Intel® Trust Authority) and may be replicated for availability and resilience. Further, in some examples, an analytics engine may consume the historical attestation evidence for further analysis, AI model training, and/or decision support.

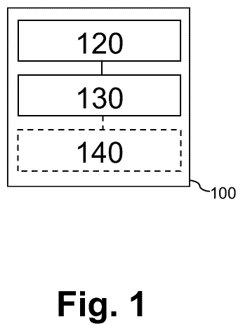

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 130 is configured to obtain a request for a seamless update of at least a part of a confidential computing environment (CCE), while the CCE is handling a workload. The CCE handles the workload by actively managing and executing the tasks, processes, and/or applications that constitute the workload. The workload refers to the set of applications, tasks, or processes that are actively managed by the CCE. This may comprise computational activities that utilize the CCE's resources, including CPU, memory, and storage, to perform their operations. This may comprise computational activities as executing applications, processing sensitive data, performing calculations, and managing tasks that require a high level of security and confidentiality.

In some examples, the handling of the workload may comprise active execution of the workload. This may comprise the workload being in an active state where it is utilizing the CCE's resources, such as CPU, memory, and storage, to perform its operations. In some examples, parts or all of the workloads may be paged out (i.e., temporarily moved to disk storage) and the CCE in this case is handling the workload by being responsible for managing the workload's execution state, memory, and operational continuity etc. In some examples, the CCE and the workload are executed on a host comprising the processing circuitry 130. In another example, the CCE and the workload are executed on a host which is not comprising the processing circuitry 130 and is communication with the processing circuitry 130 for example via the interface circuitry 120.

The CCE may comprise the workload and one or more layered environments (see also below for more details). In some examples, updating of at least a part of the CCE ma comprise the updating of the workload handled by the CCE and/or the updating of one or more layered environments of the CCE. In other words, updating at least a part of a CCE may refer to an update of the workload that is currently being handled by the CCE or it may refer to an update of one or more layered environments of the CCE or it may refer to both. Updating the workload may comprise changes made to the applications and/or processes of the workload which are currently handle by the CCE, for example which are handled in an execution environment of the CCE (such as a tenant environment). This may include deploying new versions of the application that is being executed, applying bug fixes to the application that is executed, updating application configurations, or modifying the data sets being processed. A CCE may further comprise one or more layered environments. Updating one or more of the layered environments of the CCE may comprise modifications to the underlying secure infrastructure that supports the workload. This may include updating the execution environment that is handling the workload, or updating firmware, security policies, or the hardware security modules within the CCE, or any processing resource used by the CCE or upon which the CCE depend. This update ensures that the foundational elements of the CCE maintain their integrity, security, and trustworthiness, providing a robust and secure environment for the workload. The update to one or more layered environments of the CCE may affect various layers, such as the root of trust, firmware environment, trusted platform manager environment, quoting environment, tenant environment, and migration environment.

A seamless update may refer to the process of updating a system's components in such a way that it avoids disruption to the system's ongoing operations. With respect to a workload, a seamless update comprises updating the workload or parts of the workload without terminating its handling. This may be achieved by pausing the workload or parts of the workload, saving its complete current state to persistent storage, entering the workload into a quiet state, and creating a restart log to preserve its state. Then the update will be applied, and afterward, the workload will resume from the saved state using the restart log. The persistent storage may comprise current execution registers such as the Program Counter, Instruction Register, Memory Buffer Register, Memory Address Register, Memory Data Register, Accumulator, Status Registers, Index Registers, and Stack Pointer.

A seamless update for one or more of the layered environments of the CCE may comprise updating one or more of the layered environments of the CCE without interrupting the overall functionality of the CCE and/or the workload's execution. This may include updating the execution environment (such as the tenant environment), firmware, security policies, or hardware security modules within the CCE. This process ensures that the foundational elements of the CCE maintain their integrity, security, and trustworthiness. In some examples, the processing circuitry 130 is configured to apply the seamless update to at least a part of the CCE while the CCE is handling the workload. The processing circuitry 130 may receive the request to perform the seamless update, for example, from a system administrator or an automated update management system. The processing circuitry 130 may then proceed to apply the seamless update as described above. Once the update is complete the processing circuitry 130 may resume full operations of the CCE and/or its components. This may comprise restoring the workload to its current operating state by launching the updated workload, processing the restart log, and/or restoring the saved register state—particularly if the update involves lower, trust-dependent layers of the CCE.

Further, the processing circuitry 130 is configured to generate first attestation evidence for verifying the integrity of the confidential computing environment before updating the CCE. Further, the processing circuitry 130 is configured to generate second attestation evidence for verifying the integrity of the confidential computing environment after updating the confidential computing environment. Attestation evidence may be a comprehensive set of data used to verify the integrity and security of integrity of the CEE or at least of a part of the CCE at a specific point in time. The attestation evidence may be used in an attestation process to provide verifiable proof to a verifier that the CCE and/or its components are secure, untampered with, and operating as expected, allowing the verifier to establish trust in the CCE's integrity and security status by evaluating the proof. The CCE may comprise the workload and one or more layered environments. In some examples generating the attestation evidence may comprise signing a measurement based on the workload and/or on one or more measurements based on the respective one or more layered environments of the CCE. In some examples, the attestation evidence may comprise one or more of these measurements and/or the corresponding one or more cryptographic signatures of these one or more measurements.

The first attestation evidence may be generated at a point in time before updating the CCE. The point in time before updating the CCE may refer to the moment after the processing circuitry 130 has received the request for the update but before the actual application of the update begins. For example, one or more measurements of the first evidence are taken at this specific point in time before the update is applied to the CCE. In some examples, the generating of the first attestation evidence is based on these one or more measurements of the CCE which are taken before updating.

The second attestation evidence may be generated at a point in time after the update has been applied to the CCE. In some examples, the point in time after updating the CCE refers to the exact moment when the update process has been fully completed and the updated CCE has resumed its normal operations. For instance, this point in time may be defined as the moment when the processing circuitry 130 is able to perform post-update operations, such as executing new instructions or interacting with other system components. In another example, the point in time after the updating refers to any point in time before a next update or change is applied to the CCE. In yet another example, the point in time after the updating refers to a moment in between these two. At this specific point in time after the update has been applied to the CCE, one or more measurements of the second attestation evidence are taken, ensuring that the evidence accurately reflects the state of the updated CCE. In some examples the generating of the second attestation evidence is based on these one or more measurements of the CCE which are taken after updating.

The proposed technique ensures that integrity and security of a CCE are maintained during updates, without interrupting ongoing workloads. By generating first and second attestation evidence before and after the update, it is ensured that the CCE's state is securely verified at critical points in the update process. This capability is crucial for maintaining a continuous chain of trust, particularly in environments where high levels of security and operational continuity are required, such as in financial services, healthcare, or cloud computing. The seamless update mechanism allows for real-time verification and minimal downtime, enabling the system to remain resilient against potential security threats during updates. This enhances the reliability of the CCE and also ensures that sensitive data and operations within the workload remain protected throughout the update process.

A CCE may provide specific hardware-based security features, both within the processing circuitry and across the broader computing system comprising the processing circuitry, to protect data in use from unauthorized access and tampering. In some examples, the CCE may include a Trusted Execution Environment (TEE), which is provided within the processing circuitry and creates isolated and secure areas for executing sensitive computations and storing confidential data. Memory encryption is another critical feature, ensuring that the contents of the system memory (RAM) are encrypted to protect data even if physical access to the memory is obtained. Further, features such as I/O isolation secure input/output operations, preventing data leakage during transit between the processing circuitry and peripheral devices. Together, these processing circuitry and system-level features provide a robust foundation for a CCE, ensuring that sensitive information and computations are protected throughout their lifetime. The CCE operating on the system software relies on the underlying system software for its initialization, execution, and management. The system software provides the necessary services and interfaces for the CCE to function securely and efficiently. The CCE ensures that the workload is protected from unauthorized access and tampering by leveraging hardware-based security features and cryptographic measures, maintaining the integrity and confidentiality of the data and processes throughout their execution.

The CCE may comprise one or more hierarchical layered environments. Each of the one or more layered environments may be specifically designed to perform distinct computing functions within the CCE. These layers are hierarchically structured such that a lower layer may support and attest to the integrity of a layer above it, ensuring a continuous chain of trust throughout the CCE. For example, a lower layered environment may receive a measurement from the environment layered above and sign it with its private key. The one or more layered environments may be categorized into layers based on their functions within the CCE. The layers may be logically and/or hardware-separated based on their specific functions, roles, and responsibilities within the CCE, ensuring a structured and secure computing framework. For example, there may be one or more layers designed to perform foundational security functions, including the Root of Trust (ROT). The ROT may be a hardware-based security component that provides a secure and immutable trust anchor for the layers above. The foundational security provides the essential security mechanisms and trust anchors upon which the entire framework may be built. The foundational security framework provides the base upon which the entire CCE's security relies. For example, the foundational security framework may comprise layers responsible for secure boot, cryptographic key management, and integrity verification. One example is the Device Identifier Composition Engine (DICE), which creates a chain of trust through layered identities and attestation. DICE may be defined in the specification “DICE Attestation Architecture” by the Trusted Computing Group, Version 1.1, Revision 0.18, Jan. 6, 2024. Another layer of the CCE may be the Quoting Environment (QE), which may sign measurements from higher layers and is itself attested by the lower layers of the foundational framework. The QE generates cryptographic proofs (quotes) to verify the integrity of the layers above it. For example, layered environments above the QE, such as the Tenant Environment (TE) and Migration Environment (ME), rely on these attestation proofs to ensure their secure operation. The TE executes the main computational tasks, while the ME handles the secure migration of workloads between different environments within the CCE. In some examples, the one or more layered environments of a CCE may comprise at least one of a quoting environment, a tenant environment, or a service environment. The quoting environment may be configured to collect and provide attestation reports that verify the integrity of the CCE. The tenant environment may be configured to execute a workload of the respective CCE. The service environment may be configured to provide additional services such as maintenance, updates, or security monitoring. The service environment may be a migration environment, which handles the secure migration of workloads between different environments within the CCE.

In some examples, the generating of the first attestation evidence comprises signing the one or more measurements of the CCE which are taken before updating. In some examples, the generating of the second attestation evidence comprises signing the one or more measurements of the CCE which are taken after updating. Signing a measurement may comprise generating a digital signature by encrypting a digest of the measurement, such as a hash, with a private key, thereby ensuring the authenticity and integrity of the measurement. For example, generating a digital signature may comprise creating a cryptographic hash of the measurement and then signing this hash with a private key to produce a digital signature, ensuring the integrity and authenticity of the measurement. That is, in some examples, the attestation evidence for verifying the integrity of the first CCE may comprise one or more measurements of the layered environments of the first CCE and the corresponding signatures of these measurements. A measurement together with its signature may be referred to as signed measurement. The attestation evidence may be used in an attestation process to provide verifiable proof that the system's components are secure, untampered with, and operating as expected, allowing a verifier to establish trust in the system's integrity and security status.

The CCE comprises the workload and one or more layered environments. A measurement of the CCE represents the state of a software and/or hardware component involved with the CCE at a specific point in time. A measurement can be a digest, such as a cryptographic hash, that uniquely reflects the state of the CCE and/or one or more of its components at that specific point in time. In some examples, the generation of the first attestation evidence is based on a measurement of the workload before updating. In some examples, a measurement of the CCE may comprise a measurement of the workload. In some examples, the generation of the second attestation evidence is based on a measurement of the workload after updating. The measurement of the workload may include a cryptographic hash of the workload's binary executable code, configuration data, and initial state data, ensuring that any changes due to the update are accurately captured. In some examples, the measurement may also comprise a runtime image of the workload, capturing the in-memory state of the workload during execution. In some examples, the measurement of the CCE may comprise a measurement of both the workload and the execution environment of the CCE where it is executed, such as a tenant environment. This may comprise a cryptographic hash of the workload in conjunction with the environment's state, further describing the integrity of the system.

In some examples, a measurement of the CCE may comprise one or more measurements of respective layered environments of the CCE. In some examples, the generation of the first attestation evidence is based on one or more measurements of respective layered environments of the CCE obtained before updating. Similarly, the generation of the second attestation evidence is based on corresponding measurements obtained after the update. These measurements may include cryptographic hashes of critical components such as the BIOS/UEFI, bootloader, operating system kernel, quoting environment, tenant environment, and/or migration environment. The operating system kernel measurement may capture the state of the kernel's binary code and configuration data, while the quoting environment measurement reflects the configuration and operational state and is responsible for generating trusted attestations. The tenant environment measurement may comprise hashing the isolated execution environment where workloads run, ensuring accurate reporting of its integrity.

In some examples, a measurement from a higher layer is signed by a lower layer to maintain a continuous chain of attestations also known as “chain of trust”. This may be referred to as a trust dependency between the higher layer and the lower layer. For example, the measurement of a higher layer is signed with the private key of a lower layer, and the public key of the private-public key pair of the higher layer may also be signed with the private key of the lower layer. This ensures that the public key, when used to verify the measurement, is authenticated by the lower layer's signature. A private-public key pair, also known as asymmetric cryptography or public-key cryptography, is a cryptographic tool used for secure communication and authentication. The private key is kept secret and is used to sign data, creating a digital signature that verifies the data's integrity and origin. The corresponding public key is shared openly and is used to verify the digital signature created by the private key, ensuring that the data has not been tampered with and confirming the identity of the sender. This pair enables secure data exchange and authentication without needing to share the private key, thus maintaining security.

In some examples, CCE may comprise at least one of the following layered environments: foundational environment (such as the Root of Trust (ROT)), a firmware environment, a trusted platform manager environment (which may manage the security of multiple CCEs), a quoting environment, a tenant environment and a migration environment. As described above, that the generation of the first attestation evidence may be based on one or more measurements of respective layered environments of the CCE obtained before/after updating. That is, in some examples, the generating of the first attestation evidence is based on at least one of the following: a measurement of the root of trust before updating, a measurement of the firmware environment before updating, measurement of the trusted platform manager environment before updating, a measurement of the quoting environment before updating, a measurement of the tenant environment before updating and a measurement of the migration environment before updating.

Similarly, in some examples, the generating of the first attestation evidence is based on at least one of the following: a measurement of the root of trust after updating, a measurement of the firmware environment after updating, measurement of the trusted platform manager environment after updating, a measurement of the quoting environment after updating, a measurement of the tenant environment after updating and a measurement of the migration environment after updating.

The integrity of upper layered environments may depend on the integrity of lower layered environments, that is there may be a trust dependency between of the layers of CCE. This trust dependency may apply to measurements taken before the updating and to measurements taken after the updating.

In some examples, least one of the following trust dependencies applies before updating applies: a signed measurement of the tenant environment before updating has a trusted dependency on the quoting environment, a signed measurement of the quoting environment before updating has a trust dependency on the trusted platform environment, a signed measurement of the trusted platform before updating has a trust dependency on the package firmware environment, and a signed measurement of the firmware environment before updating has a trust dependency on the root of trust of a processor executing the CCE. For example, the ROT, as the lowest layer and part of the processing circuitry 130, may receive a measurement taken before updating from the firmware. The ROT signs the measurement of the firmware with its private key and also signs the public key of the firmware. Next, the firmware environment receives a measurement taken before updating of the trusted platform manager environment, signs it with its private key, and also signs the public key of the trusted platform manager. It may also include the previously signed measurement from the RoT. For example, this process may continue for further subsequent layers, for example up to the QE. The QE then receives measurements taken before updating from higher layers, such as the TE and ME, and signs them with its private key. The corresponding public key is verified by the lower layers. Further, it may include signatures from lower layers which are attested down to the ROT as described above. This hierarchical signing process ensures that each layer's integrity is verifiable, creating a robust chain of trust throughout the CCE.

Similarly, in some examples, least one of the following trust dependencies applies after updating applies: a signed measurement of the tenant environment after updating has a trusted dependency on the quoting environment, a signed measurement of the quoting environment after updating has a trust dependency on the trusted platform environment, a signed measurement of the trusted platform after updating has a trust dependency on the package firmware environment, and a signed measurement of the firmware environment after updating has a trust dependency on the root of trust of a processor executing the confidential computing environment. For example, the ROT, as the lowest layer and part of the processing circuitry 130, may receive a measurement taken after updating from the firmware. The RoT signs the measurement of the firmware with its private key and also signs the public key of the firmware. Next, the firmware environment receives a measurement taken after updating of the trusted platform manager environment, signs it with its private key, and also signs the public key of the trusted platform manager. It may also include the previously signed measurement from the RoT. For example, this process may continue for further subsequent layers, for example up to the QE. The QE then receives measurements taken after updating from higher layers, such as the TE and ME, and signs them with its private key. The corresponding public key is verified by the lower layers. Further, it may include signatures from lower layers which are attested down to the ROT as described above. This hierarchical signing process ensures that each layer's integrity is verifiable, creating a robust chain of trust throughout the CCE.

The recognition of trust dependencies between layers means that the integrity of higher layers is inherently linked to the security of the lower layers, reinforcing the overall security architecture. This comprehensive and interdependent measurement process secures the CCE during updates and also maintains a continuous chain of trust across all layers, thereby enhancing the reliability and security of the system in environments where maintaining trust is critical.

In some examples, the attestation evidence may comprise at least one of the following: One or more measurements, the corresponding signatures of these measurements, the corresponding public keys, and the signatures of these public keys. Additionally, the attestation evidence may include configuration data, telemetry data, and/or inference data. Configuration data may comprise initial settings for the execution of the software image being measured, such as default operational states like tick counters and file descriptor states. Telemetry data may include operational metrics available to the running image, such as memory usage, CPU cycles, and power cycles, providing insights into the system's performance. Inference data may comprise operations performed by the software image that relate to the integrity of the environment, such as extending the environment with runtime images. The inference data might include a manifest structure containing a Merkle Tree of digests of the extended images.

As described above handling of the workload may refer to active execution of the workload and/or parts or all of the workloads being paged out (i.e., temporarily moved to disk storage). That is in some examples, the workload is executed by the CCE when generating the first and/or second evidence.

In some examples, the workload is swapped out by the CCE when generating the first and/or second evidence. In some examples, the generating of the first attestation evidence and/or the generating of the second attestation evidence is based on a swap page start address and a swap page end address comprising the workload.

As described above handling of the workload may refer to active execution of the workload and/or parts or all of the workloads being swapped out (also referred to paged out). That is in some examples, the workload is executed by the CCE when generating the first and/or second evidence. That is in some examples, the workload is executed by the CCE when generating the first and/or second evidence. When the workload is actively executed within the CCE, the handling of the workload refers to its active state, where it is fully utilizing the resources of the CCE, such as CPU, memory, and storage. In this case, the generation of the first and/or second attestation evidence may be based on measurements taken from the workload in its active state. These measurements may include a cryptographic hash of the workload's binary executable code, configuration data, and initial state data, ensuring that any changes due to the update are accurately captured. The measurement may also include the runtime image of the workload, capturing the in-memory state during execution. This process ensures that the integrity of the workload is maintained while it is being executed, providing a secure and trustworthy environment even as updates are applied.

In some examples, the workload is swapped out by the CCE when generating the first and/or second attestation evidence, meaning that parts or all of the workload are temporarily moved from active memory to disk storage. In this state, the workload is not actively running but is instead in a dormant state, ready to be reactivated when needed. The swapped-out workload's state, which may comprise information to restore it to its active state, such as its data, code, and execution context, may be captured in the workload measurement. Specifically, the measurement of the workload may comprise a cryptographic hash of this swapped-out state, ensuring that the integrity of the workload is preserved even when it is not actively executing. The generation of the first and/or second attestation evidence may be based on the swap page start address and swap page end address, which define the memory boundaries of the swapped-out workload on disk. By measuring the workload's state as defined by these swap page boundaries, the system can accurately verify the integrity of the workload's dormant state.

The processing circuitry 130 may be further configured to include the first attestation evidence and the second attestation evidence into a collection of attestation evidence associated with the workload. The collection of attestation evidence may comprise attestation evidence for verifying the integrity of all CCEs that the workload was deployed to during its lifetime. The attestation evidence collection may comprise a one or more attestation evidence corresponding to the workload, that is a one or more attestation evidence that is generated during the lifetime of the workload. The attestation evidence collection creates a long-term picture of the workload's trust properties as it evolves and further attestation evidence for the collection may be generated as a response to security events that result in a workload image update or an update of the CCE or a change of a CCE during the lifetime of the workload. In some examples, the collection of attestation evidence associated with the workload comprises attestation evidence for verifying the integrity of the CCE before and after each update of the workload and/or the CCE. In other words, in some examples, the attestation evidence collection comprises attestation evidence generated before and after some or all updates that were apply to the workload and/or the CCE during the lifetime of the workload. In another example, the CCE may be changed during the lifetime of the workload attestation evidence before and after the change of the CCE may be included into the attestation evidence collection.

For example, the collection of attestation evidence may be provided a verifier in addition to a current attestation evidence to prove the integrity of the workload during its complete lifetime. Collecting attestation evidence during the lifetime of the workload may give a comprehensive description of the security risks that the workload may have been subject to. Maintaining a history of evidence across the lifetime of the workload enables chain-of-custody for execution environments.

In some examples, the first attestation evidence, the second attestation evidence and/or the collection of attestation evidence associated with the workload are stored in a security attestation data format. A security attestation data format may be a standardized structure used to encode, store, and transmit attestation evidence, ensuring that the data is secure, consistent, and interoperable across different systems and platforms. In this format one or more of the following may be stored: cryptographic signatures, hashed measurements, and metadata that describe the state of the system or environment at specific points in time. The attestation evidence and/or the collection of attestation evidence is stored in the security attestation data format to ensure that it remains secure, verifiable, and interoperable across different systems and platforms. This standardized format allows for consistent encoding, storage, and transmission of attestation evidence, for maintaining the integrity and trustworthiness of the CCE over time. By using such a format, the system may ensure that the evidence is easily accessible and interpretable by different entities, including verifiers, who may need to assess the system's security state. Additionally, storing attestation evidence in a standardized format enables seamless integration with various tools and services, such as analytics engines, that may consume this data for further analysis, AI model training, or decision support, ensuring that the evidence can be effectively utilized in a wide range of scenarios.

In some examples, the security attestation data format is at least one of a Trusted Computing Group Concise, TCG, concise evidence data format, a Trusted Computing Group Device Identifier Composition Engine Trustworthy Computing Base Information and Initialization, TCG DICE TCBINFO, or concise evidence data format, an Internet Engineering Task Force, IETF, Conceptual Message Wrapper, or IETF Entity Attestation Token, EAT, re other such data format.

For instance, the Trusted Computing Group (TCG) Concise Evidence Data Format is designed to efficiently represent attestation evidence in a compact form, suitable for environments where bandwidth or storage is limited. The TCG Device Identifier Composition Engine (DICE) Trustworthy Computing Base Information (TCBINFO) Data Format is tailored for devices that use the DICE architecture, enabling secure management of device identities and lifetime through a format that encodes attestation evidence for verifying the trustworthiness of individual components. The Internet Engineering Task Force (IETF) Conceptual Message Wrapper (CMW) is a versatile format that wraps various types of attestation evidence in a standardized message structure, facilitating the transmission and processing of attestation data across different networks and systems. Another example is the IETF Entity Attestation Token (EAT) Data Format, which provides a standardized way to convey claims about the state of a device or environment, making it easier to assess and verify the security and integrity of systems in diverse settings.

Further, the attestation evidence and or the attestation evidence collection may follow one or more of the following industry standard representations: the specification “RATS Conceptual Messages Wrapper (CMW)”, by the authors Henk Birkholz and Ned Smith and Thomas Fossati and Hannes Tschofenig, published by the Internet Engineering Task Force on Jul. 24, 2024; the specification “The Entity Attestation Token (EAT)”, by the authors Laurence Lundblade, Giridhar Mandyam, Jeremy O'Donoghue, Carl Wallace, published Internet Engineering Task Force Aug. 2, 2024; the specification “DICE Attestation Architecture” by the Trusted Computing Group, Version 1.1, Revision 0.18, Jan. 6, 2024; the specification “TCG DICE Concise Evidence Binding for SPDM, by the Trusted Computing Group, Version 1.0, Revision 0.54, Jan. 17, 2024.

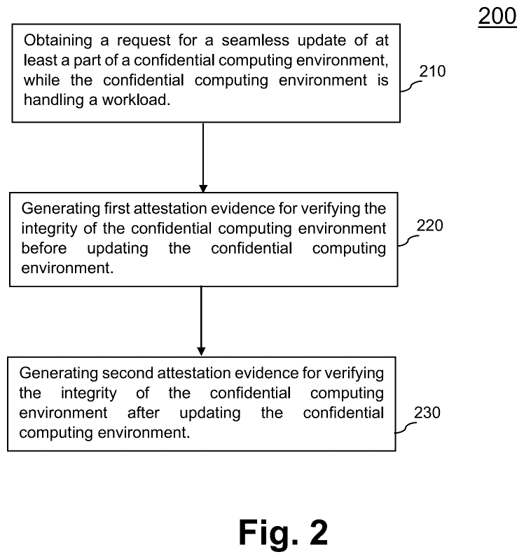

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-5).

FIG. 2 illustrates a flowchart of an example of a method 200. The method 200 may, for instance, be performed by an apparatus as described herein, such as apparatus 100. The method 200 comprises obtaining 210 a request for a seamless update of at least a part of a confidential computing environment, while the confidential computing environment is handling a workload. The method 200 further comprises generating 220 first attestation evidence for verifying the integrity of the confidential computing environment before updating the confidential computing environment. The method 200 further comprises generating 230 second attestation evidence for verifying the integrity of the confidential computing environment after updating the confidential computing environment.

More details and aspects of the method 200 are explained in connection with the proposed technique or one or more examples described above, e.g., with reference to FIG. 1. The method 200 may comprise one or more additional optional features corresponding to one or more aspects of the proposed technique, or one or more examples described above.

### Further Examples

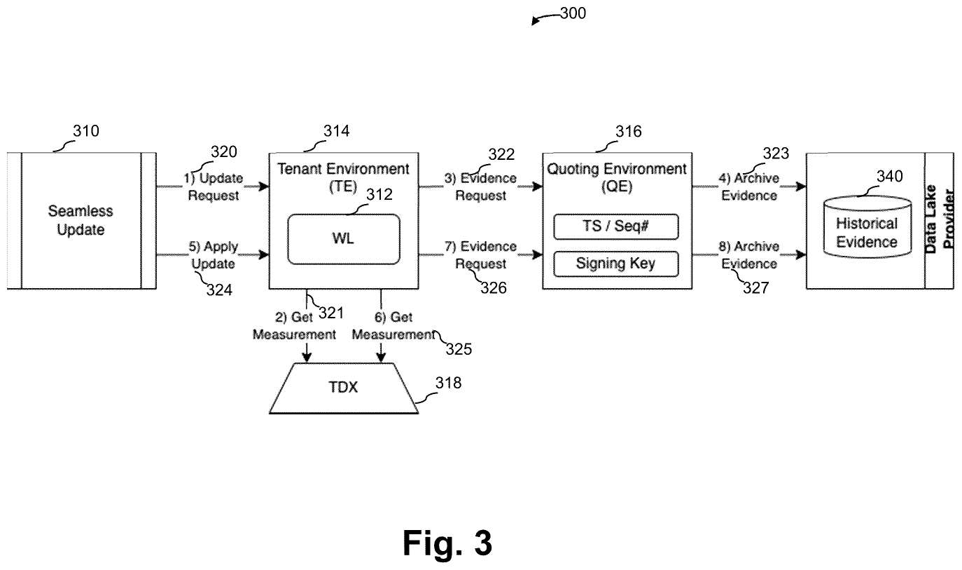

FIG. 3 illustrates a flow chart 300 of a seamless update applied to a workload in a CCE with a collection of historical attestation evidence collection. For example, the CCE 318 may be Intel® TDX. The workload (WL) 312 is present in both the pre-update environment and the post-update environment. The WL 312 security depends on the security of both pre-update and post-update environments. The workload 312 may be handled by the execution environment, tenant environment (TE), 314. In step 320, a seamless update request 310 of the TE 314 and/or the workload 312 is delivered to the CCE 318, for example to the TE 314, handling the workload 312. In step 321, the TE 314 requests to collect a first measurement of the TE 314 and the WL 312. The request to collect the measurement is delivered to the CCE 318 (for example the TDX). In step 322, the first measurement is delivered to the QE 316 to be signed (and in some examples also time stamped), which yields the first attestation evidence. The first attestation evidence is now available for attesting to remote entities. The first attestation evidence describes the trustworthiness state of the TE 314 and WL 310. In step 323, first attestation evidence is archived as historical attestation evidence in the attestation evidence collection 340 (also referred to as historical evidence). In some examples, the attestation evidence collection 340 may be stored using a data lake provider. In step 324, the update is applied to the TE 314 and/or the workload. In step 325, post-updated TE 314 requests the CCE 318 (for example the TDX) to collect a second measurement of the TE 314 and the WL 312. In step 326, the second measurement is delivered to the QE 316 to be signed and timestamped, which yields the second attestation evidence. The second attestation evidence describes the trustworthiness state of the TE 314 and WL 310. In step 327, the second attestation evidence is archived into the attestation evidence collection 340.

For example, the above described steps may be repeated for each update applied during the lifetime of the workload. Collecting attestation evidence during the lifetime of the workload may give a comprehensive description of the security risks that the workload may have been subject to. Maintaining a history of evidence across the lifetime of the WL enables chain-of-custody for execution environments. The attestation evidence collection (historical evidence) may be inspected for a variety of reasons (service level agreement compliance, chain of custody, audit, security events, analytics, AI training, a Trust-as-a-Service (TaaS) etc.). This may be provided to these services in addition to a current attestation evidence.

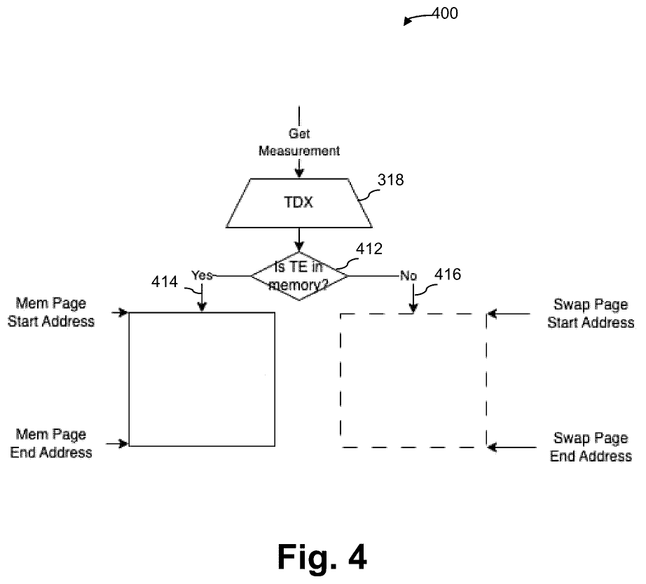

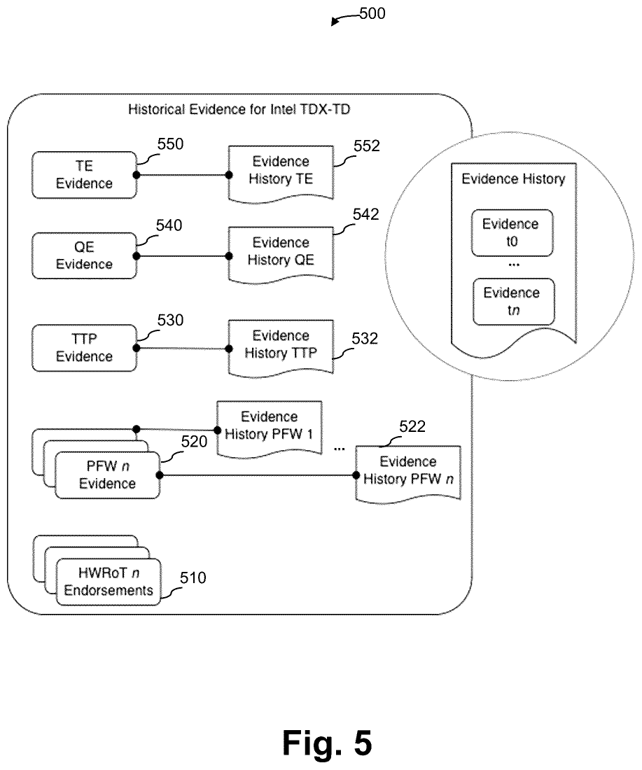

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-5).

FIG. 4 illustrates a CCE runtime measurement 400 of a swapped out workload. The workload 310 executing in the CCE 318 may be swapped out (also referred to as paged out) of CCE memory (for example TDX memory) as part of multi-processing scheduling. Attestation evidence (for example the first and/or the second attestation evidence) of the paged image may still be obtained even when the WL 312 and/or the TE 314 isn't currently running. In step 412 it is asked if the TE 314 and/or the WL 312 is in the memory of the CCE 318. If the answer is yes, then it is proceeded with step 414. If the TE 314 and/or the WL 312 are in the memory, that is the WL 312 is executing, the measurement of the TE 314 and/or the WL 312 is obtained form based on the memory page start address to the on the memory page end address of the WL 312. If the answer in step 412 is no, then it is proceeded with step 416. If the TE 314 and/or the WL 312 are not in the memory, that is in the swapped out state, the TE 314 can't request to be measured by the QE 316, in other words the TE 314 cannot request its own attestation from CCE 318. Instead, QE 316 may invoke the measurement request resulting in the CCE module (for example the TDX Module) identifying the swap page start address and swap page end address, where WL 312 is stored. Then these identified swap pages are measured, and the QE 316 generates the requested attestation evidence as described above. This enables a swapped out WL 312 to be measured prior to applying a seamless update without forcing the WL 312 on to a run queue.

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIG. 5).

FIG. 5 illustrates an attestation evidence collection architecture 500. The attestation evidence collection architecture 500 shows the attestation evidence collection based on a the CCE comprising the following layer environments: One or more hardware roots of trust (RoTs) 510 exist in the processing circuitry (for example a CPU, GPU, XPU, or IPU). The one or more RoTs 510 each have associated endorsement manifests or certificates that describe the security properties of the RoT. The processing circuitries have a platform firmware 520 that implements a measured or secure boot capability that is first measured such that attestation evidence 520 for each is generated. The attestation evidence of the firmware 520 is added into an attestation evidence collection of the firmware 522 (also referred to as evidence history of the firmware). The one or more processing circuitries load a trusted platform manager 530 (such as a TEE Trusted Platform (TTP) firmware) that configures the rest of the CCE including the creation of the quoting environment (QE) 540 and the tenant environments (TEs) 550. The attestation evidence of the TTP 530 is added into an attestation evidence collection of the TTP 532. The attestation evidence of the QE 540 is added into an attestation evidence collection of the QE 542. The attestation evidence of the TEs 550 is added into an attestation evidence collection of the TEs 552. Each of these modules in the layered environment of the CCE may be subject to update (except the RoT). If a module is updated, similar attention is given to capturing pre-update and post-update snapshots of evidence as described in FIG. 3. The attestation evidence collection structure may be constructed using industry standards such as described in the document “RATS Conceptual Messages Wrapper (CMW)”, by the authors Henk Birkholz and Ned Smith and Thomas Fossati and Hannes Tschofenig, published by the Internet Engineering Task Force on Jul. 24, 2024.

Further details and aspects are mentioned in connection with the examples described above. The example shown in FIG. 5 may include one or more optional additional features corresponding to one or more aspects mentioned in connection with the proposed concept or one or more examples described above (e.g., FIGS. 1-4).

In some examples, a seamless update may not be applied for example, if resiliency hardware isn't available that transitions to the bootstrap/attesting environment where the measurements of the next layer may be taken securely. However, a history of previous bootstrap events may be reported to and recorded by a data lake provider.

In the following, some examples of the proposed concept are presented:
An example (e.g., example 1) relates to an apparatus comprising interface circuitry, machine-readable instructions and processing circuitry to execute the machine-readable instructions to obtain a request for a seamless update of at least a part of a confidential computing environment, while the confidential computing environment is handling a workload, generate first attestation evidence for verifying the integrity of the confidential computing environment before updating the confidential computing environment, generate second attestation evidence for verifying the integrity of the confidential computing environment after updating the confidential computing environment.
Another example (e.g., example 2) relates to a previous example (e.g., example 1) or to any other example, further comprising that the processing circuitry is further to execute the machine-readable instructions to apply the seamless update to the at least part of the confidential computing environment, while the confidential computing environment is handling the workload.
Another example (e.g., example 3) relates to a previous example (e.g., one of the examples 1 to 2) or to any other example, further comprising that the processing circuitry is further to execute the machine-readable instructions to include the first attestation evidence and the second attestation evidence into a collection of attestation evidence associated with the workload.
Another example (e.g., example 4) relates to a previous example (e.g., example 3) or to any other example, further comprising that the collection of attestation evidence associated with the workload comprising attestation evidence for verifying the integrity of the confidential computing environment before and after each update of the workload and/or of the confidential computing environment.
Another example (e.g., example 5) relates to a previous example (e.g., one of the examples 1 to 4) or to any other example, further comprising that the generating of the first attestation evidence is based on one or more measurements of the confidential computing environment which are taken before updating, and wherein the generating of the second attestation evidence is based on one or more measurements of the confidential computing environment which are taken after updating.
Another example (e.g., example 6) relates to a previous example (e.g., one of the examples 1 to 5) or to any other example, further comprising that the generating of the first attestation evidence comprises signing one or more measurements of the confidential computing environment which are taken before updating, and wherein the generating of the second attestation evidence comprises signing one or more measurements of the confidential computing environment which are taken after updating.
Another example (e.g., example 7) relates to a previous example (e.g., one of the examples 1 to 6) or to any other example, further comprising that a generating of the first attestation evidence is based on a measurement the workload before updating, and wherein a generating of the second attestation evidence is based on a measurement of the workload after updating.
Another example (e.g., example 8) relates to a previous example (e.g., one of the examples 1 to 7) or to any other example, further comprising that generating of the first attestation evidence is based on one or more measurements of respective one or more layered environments of the confidential computing environment obtained before updating, and wherein generating of the second attestation evidence is based on one or more measurements of respective one or more layered environments of the confidential computing environment obtained after updating.
Another example (e.g., example 9) relates to a previous example (e.g., one of the examples 1 to 8) or to any other example, further comprising that the confidential computing environment comprise at least one of the following layered environments a root of trust, a firmware environment, a trusted platform manager environment, a quoting environment, a tenant environment and a migration environment.
Another example (e.g., example 10) relates to a previous example (e.g., example 9) or to any other example, further comprising that generating of the first attestation evidence is based on at least one of the following a measurement of the root of trust before updating, a measurement of the firmware environment before updating, measurement of the trusted platform manager environment before updating, a measurement of the quoting environment before updating, a measurement of the tenant environment before updating and a measurement of the migration environment before updating.
Another example (e.g., example 11) relates to a previous example (e.g., one of the examples 9 to 10) or to any other example, further comprising that at least one of the following trust dependencies applies a signed measurement of the tenant environment before updating has a trusted dependency on the quoting environment, a signed measurement of the quoting environment before updating has a trust dependency on the trusted platform environment, a signed measurement of the trusted platform before updating has a trust dependency on the package firmware environment, and a signed measurement of the firmware environment before updating has a trust dependency on the root of trust of a processor executing the confidential computing environment.
Another example (e.g., example 12) relates to a previous example (e.g., one of the examples 9 to 11) or to any other example, further comprising that generating of the first attestation evidence is based on at least one of the following a measurement of the root of trust after updating, a measurement of the firmware environment after updating, measurement of the trusted platform manager environment after updating, a measurement of the quoting environment after updating, a measurement of the tenant environment after updating and a measurement of the migration environment after updating.
Another example (e.g., example 13) relates to a previous example (e.g., one of the examples 9 to 12) or to any other example, further comprising that at least one of the following trust dependencies applies a signed measurement of the tenant environment after updating has a trusted dependency on the quoting environment, a signed measurement of the quoting environment after updating has a trust dependency on the trusted platform environment, a signed measurement of the trusted platform after updating has a trust dependency on the package firmware environment, and a signed measurement of the firmware environment after updating has a trust dependency on the root of trust of a processor executing the confidential computing environment.
Another example (e.g., example 14) relates to a previous example (e.g., one of the examples 1 to 13) or to any other example, further comprising that the updating of at least a part of the confidential computing environment comprises the updating of the workload handled by the confidential computing environment and/or the updating of one or more layered environments of the confidential computing environment.
Another example (e.g., example 15) relates to a previous example (e.g., one of the examples 1 to 14) or to any other example, further comprising that the workload is executed by the confidential computing environment when generating the first and/or second evidence.
Another example (e.g., example 16) relates to a previous example (e.g., one of the examples 1 to 15) or to any other example, further comprising that the workload is swapped out by the confidential computing environment when generating the first and/or second evidence.
Another example (e.g., example 17) relates to a previous example (e.g., example 16) or to any other example, further comprising that the generating of the first attestation evidence and/or the generating of the second attestation evidence is based on a swap page start address and a swap page end address comprising the workload.
Another example (e.g., example 18) relates to a previous example (e.g., one of the examples 1 to 17) or to any other example, further comprising that first attestation evidence, the second attestation evidence and/or the collection of attestation evidence associated with the workload are stored in a security attestation data format.
Another example (e.g., example 19) relates to a previous example (e.g., example 18) or to any other example, further comprising that the security attestation data format is at least one of a Trusted Computing Group Concise, TCG, concise evidence data format, a Trusted Computing Group Device Identifier Composition Engine Trustworthy Component Brokering and Initialization, TCG DICE concise evidence data format, an Internet Engineering Task Force, IETF, Conceptual Message Wrapper, or IETF Entity Attestation Token, EAT, data format.
An example (e.g., example 20) relates to a method comprising obtaining a request for a seamless update of at least a part of a confidential computing environment, while the confidential computing environment is handling a workload, generating first attestation evidence for verifying the integrity of the confidential computing environment before updating the confidential computing environment, generating second attestation evidence for verifying the integrity of the confidential computing environment after updating the confidential computing environment.
Another example (e.g., example 21) relates to a previous example (e.g., example 20) or to any other example, further comprising applying the seamless update to the at least part of the confidential computing environment, while the confidential computing environment is handling the workload.
Another example (e.g., example 22) relates to a previous example (e.g., one of the examples 20 to 21) or to any other example, further comprising including the first attestation evidence and the second attestation evidence into a collection of attestation evidence associated with the workload.
Another example (e.g., example 23) relates to a previous example (e.g., example 22) or to any other example, further comprising that the collection of attestation evidence associated with the workload comprising attestation evidence for verifying the integrity of the confidential computing environment before and after each update of the workload and/or of the confidential computing environment.
Another example (e.g., example 24) relates to a previous example (e.g., one of the examples 20 to 23) or to any other example, further comprising that the generating of the first attestation evidence is based on one or more measurements of the confidential computing environment which are taken before updating, and wherein the generating of the second attestation evidence is based on one or more measurements of the confidential computing environment which are taken after updating.
Another example (e.g., example 25) relates to a previous example (e.g., one of the examples 20 to 24) or to any other example, further comprising that the generating of the first attestation evidence comprises signing one or more measurements of the confidential computing environment which are taken before updating, and wherein the generating of the second attestation evidence comprises signing one or more measurements of the confidential computing environment which are taken after updating.
Another example (e.g., example 26) relates to a previous example (e.g., one of the examples 20 to 25) or to any other example, further comprising that a generating of the first attestation evidence is based on a measurement the workload before updating, and wherein a generating of the second attestation evidence is based on a measurement of the workload after updating.
Another example (e.g., example 27) relates to a previous example (e.g., one of the examples 20 to 26) or to any other example, further comprising that generating of the first attestation evidence is based on one or more measurements of respective one or more layered environments of the confidential computing environment obtained before updating, and wherein generating of the second attestation evidence is based on one or more measurements of respective one or more layered environments of the confidential computing environment obtained after updating.
Another example (e.g., example 28) relates to a previous example (e.g., one of the examples 20 to 27) or to any other example, further comprising that the confidential computing environment comprise at least one of the following layered environments a root of trust, a firmware environment, a trusted platform manager environment, a quoting environment, a tenant environment and a migration environment.
Another example (e.g., example 29) relates to a previous example (e.g., example 28) or to any other example, further comprising that generating of the first attestation evidence is based on at least one of the following a measurement of the root of trust before updating, a measurement of the firmware environment before updating, measurement of the trusted platform manager environment before updating, a measurement of the quoting environment before updating, a measurement of the tenant environment before updating and a measurement of the migration environment before updating.
Another example (e.g., example 30) relates to a previous example (e.g., one of the examples 28 to 29) or to any other example, further comprising that at least one of the following trust dependencies applies a signed measurement of the tenant environment before updating has a trusted dependency on the quoting environment, a signed measurement of the quoting environment before updating has a trust dependency on the trusted platform environment, a signed measurement of the trusted platform before updating has a trust dependency on the package firmware environment, and a signed measurement of the firmware environment before updating has a trust dependency on the root of trust of a processor executing the confidential computing environment.
Another example (e.g., example 31) relates to a previous example (e.g., one of the examples 28 to 30) or to any other example, further comprising that generating of the first attestation evidence is based on at least one of the following a measurement of the root of trust after updating, a measurement of the firmware environment after updating, measurement of the trusted platform manager environment after updating, a measurement of the quoting environment after updating, a measurement of the tenant environment after updating and a measurement of the migration environment after updating.
Another example (e.g., example 32) relates to a previous example (e.g., one of the examples 28 to 31) or to any other example, further comprising that at least one of the following trust dependencies applies a signed measurement of the tenant environment after updating has a trusted dependency on the quoting environment, a signed measurement of the quoting environment after updating has a trust dependency on the trusted platform environment, a signed measurement of the trusted platform after updating has a trust dependency on the package firmware environment, and a signed measurement of the firmware environment after updating has a trust dependency on the root of trust of a processor executing the confidential computing environment.
Another example (e.g., example 33) relates to a previous example (e.g., one of the examples 20 to 32) or to any other example, further comprising that the updating of at least a part of the confidential computing environment comprises the updating of the workload handled by the confidential computing environment and/or the updating of one or more layered environments of the confidential computing environment.
Another example (e.g., example 34) relates to a previous example (e.g., one of the examples 20 to 33) or to any other example, further comprising that the workload is executed by the confidential computing environment when generating the first and/or second evidence.
Another example (e.g., example 35) relates to a previous example (e.g., one of the examples 20 to 34) or to any other example, further comprising that the workload is swapped out by the confidential computing environment when generating the first and/or second evidence.
Another example (e.g., example 36) relates to a previous example (e.g., example 35) or to any other example, further comprising that the generating of the first attestation evidence and/or the generating of the second attestation evidence is based on a swap page start address and a swap page end address comprising the workload.
Another example (e.g., example 37) relates to a previous example (e.g., one of the examples 20 to 36) or to any other example, further comprising that first attestation evidence, the second attestation evidence and/or the collection of attestation evidence associated with the workload are stored in a security attestation data format.
Another example (e.g., example 38) relates to a previous example (e.g., example 37) or to any other example, further comprising that the security attestation data format is at least one of a Trusted Computing Group Concise, TCG, concise evidence data format, a Trusted Computing Group Device Identifier Composition Engine Trustworthy Component Brokering and Initialization, TCG DICE TCBINFO, concise evidence data format, an Internet Engineering Task Force, IETF, Conceptual Message Wrapper, or IETF Entity Attestation Token, EAT, data format.
An example (e.g., example 39) relates to an apparatus comprising processor circuitry configured to obtain a request for a seamless update of at least a part of a confidential computing environment, while the confidential computing environment is handling a workload, generate first attestation evidence for verifying the integrity of the confidential computing environment before updating the confidential computing environment, generate second attestation evidence for verifying the integrity of the confidential computing environment after updating the confidential computing environment.
An example (e.g., example 40) relates to a device comprising means for processing for obtaining a request for a seamless update of at least a part of a confidential computing environment, while the confidential computing environment is handling a workload, generating first attestation evidence for verifying the integrity of the confidential computing environment before updating the confidential computing environment, generating second attestation evidence for verifying the integrity of the confidential computing environment after updating the confidential computing environment.
Another example (e.g., example 41) relates to a non-transitory machine-readable storage medium including program code, when executed, to cause a machine to perform the example of any one of examples 20 to 38.
Another example (e.g., example 42) relates to a computer program having a program code for performing the example of any one of examples 20 to 38 when the computer program is executed on a computer, a processor, or a programmable hardware component.
Another example (e.g., example 43) relates to machine-readable storage including machine readable instructions, when executed, to implement a method or realize an apparatus as claimed in any pending examples.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processing circuitry to execute the machine-readable instructions to:
obtain a request for a seamless update of at least a part of a confidential computing environment, while the confidential computing environment is handling a workload;
generate first attestation evidence for verifying the integrity of the confidential computing environment before updating the confidential computing environment;
generate second attestation evidence for verifying the integrity of the confidential computing environment after updating the confidential computing environment.

2. The apparatus of claim 1, wherein the processing circuitry is further to execute the machine-readable instructions to apply the seamless update to the at least part of the confidential computing environment, while the confidential computing environment is handling the workload.

3. The apparatus of claim 1, wherein the processing circuitry is further to execute the machine-readable instructions to include the first attestation evidence and the second attestation evidence into a collection of attestation evidence associated with the workload.

4. The apparatus of claim 3, wherein the collection of attestation evidence associated with the workload comprising attestation evidence for verifying the integrity of the confidential computing environment before and after each update of the workload and/or of the confidential computing environment.

5. The apparatus of claim 1, wherein the generating of the first attestation evidence is based on one or more measurements of the confidential computing environment which are taken before updating, and wherein the generating of the second attestation evidence is based on one or more measurements of the confidential computing environment which are taken after updating.

6. The apparatus of claim 1, wherein the generating of the first attestation evidence comprises signing one or more measurements of the confidential computing environment which are taken before updating, and wherein the generating of the second attestation evidence comprises signing one or more measurements of the confidential computing environment which are taken after updating.

7. The apparatus of claim 1, wherein a generating of the first attestation evidence is based on a measurement the workload before updating; and wherein a generating of the second attestation evidence is based on a measurement of the workload after updating.

8. The apparatus of claim 1, wherein generating of the first attestation evidence is based on one or more measurements of respective one or more layered environments of the confidential computing environment obtained before updating; and wherein generating of the second attestation evidence is based on one or more measurements of respective one or more layered environments of the confidential computing environment obtained after updating.

9. The apparatus of claim 1, wherein the confidential computing environment comprise at least one of the following layered environments: a root of trust, a firmware environment, a trusted platform manager environment, a quoting environment, a tenant environment and a migration environment.

10. The apparatus of claim 9, wherein generating of the first attestation evidence is based on at least one of the following: a measurement of the root of trust before updating, a measurement of the firmware environment before updating, measurement of the trusted platform manager environment before updating, a measurement of the quoting environment before updating, a measurement of the tenant environment before updating and a measurement of the migration environment before updating.

11. The apparatus of claim 9, wherein at least one of the following trust dependencies applies: a signed measurement of the tenant environment before updating has a trusted dependency on the quoting environment, a signed measurement of the quoting environment before updating has a trust dependency on the trusted platform environment, a signed measurement of the trusted platform before updating has a trust dependency on the package firmware environment, and a signed measurement of the firmware environment before updating has a trust dependency on the root of trust of a processor executing the confidential computing environment.

12. The apparatus of claim 9, wherein generating of the first attestation evidence is based on at least one of the following: a measurement of the root of trust after updating, a measurement of the firmware environment after updating, measurement of the trusted platform manager environment after updating, a measurement of the quoting environment after updating, a measurement of the tenant environment after updating and a measurement of the migration environment after updating.

13. The apparatus of claim 9, wherein at least one of the following trust dependencies applies: a signed measurement of the tenant environment after updating has a trusted dependency on the quoting environment, a signed measurement of the quoting environment after updating has a trust dependency on the trusted platform environment, a signed measurement of the trusted platform after updating has a trust dependency on the package firmware environment, and a signed measurement of the firmware environment after updating has a trust dependency on the root of trust of a processor executing the confidential computing environment.

14. The apparatus of claim 1, wherein the updating of at least a part of the confidential computing environment comprises the updating of the workload handled by the confidential computing environment and/or the updating of one or more layered environments of the confidential computing environment.

15. The apparatus of claim 1, wherein the workload is executed by the confidential computing environment when generating the first and/or second evidence.

16. The apparatus of claim 1, wherein the workload is swapped out by the confidential computing environment when generating the first and/or second evidence.

17. The apparatus of claim 1, wherein the generating of the first attestation evidence and/or the generating of the second attestation evidence is based on a swap page start address and a swap page end address comprising the workload.

18. The apparatus of claim 1, wherein first attestation evidence, the second attestation evidence and/or the collection of attestation evidence associated with the workload are stored in a security attestation data format.

19. A method comprising:
obtaining a request for a seamless update of at least a part of a confidential computing environment, while the confidential computing environment is handling a workload;
generating first attestation evidence for verifying the integrity of the confidential computing environment before updating the confidential computing environment;
generating second attestation evidence for verifying the integrity of the confidential computing environment after updating the confidential computing environment.

20. A non-transitory machine-readable storage medium including program code, when executed, to cause a machine to perform the method of claim 19.
